(19) United States
(12) Patent Application Publication
(10) Pub. No.: US 2025/0279854 A1
(43) Pub. Date: Sep. 4, 2025

(54) TERMINAL, RADIO BASE STATION AND RADIO COMMUNICATION METHOD

(71) Applicant: NTT DOCOMO, INC., Tokyo (JP)

(72) Inventors: Tianyang Min, Tokyo (JP); Tadashi Uchiyama, Tokyo (JP)

(73) Assignee: NTT DOCOMO, INC., Tokyo (JP)

(21) Appl. No.: 18/702,533

(22) PCT Filed: Oct. 21, 2021
(86) PCT No.: PCT/JP2021/038995

§ 371 Date: Apr. 18, 2024

(51) Int. Cl. H04L 1/08; H04W 28/04; H04W 76/20

(52) U.S. Cl. CPC H04L 1/08; H04W 28/04; H04W 76/20

(57) ABSTRACT

A terminal transmits uplink data to a first radio base station and a second radio base station. The terminal receives a first negative response of an automatic retransmission request of the uplink data from the first radio base station and receives a second negative response of the automatic retransmission request from the second radio base station. The terminal applies a duplication of uplink data based on a sum of the number of first negative responses and the number of second negative responses, or either the number of first negative responses or the number of second negative responses.

### TECHNICAL FIELD

The present disclosure relates to a terminal, a radio base station and a radio communication method for improving redundancy of transmission data.

### BACKGROUND ART

The 3rd Generation Partnership Project (3GPP) has specified the 5th generation mobile communication system (also called 5G, New Radio (NR) or Next Generation (NG)) and is also promoting specification of the next generation called “Beyond 5G”, “5G Evolution” or “6G”.

With regard to the support of Industrial Internet of Things (IIoT) and URLLC (Ultra-Reliable and Low Latency Communications), the 3GPP Release-17 is considering a function to automatically increase the redundancy of transmitted data when a communication quality between the terminal (User Equipment, UE) and the radio base station (gNB) in the radio section deteriorates (Non-Patent Literature 1).

Specifically, the UE continuously receives a negative response (HARQ-NACK) of a hybrid automatic repeat request (HARQ), and when a state in which the communication quality of the radio section (between the UE and the gNB) is degraded (the state may be called “survival time state (ST state)”) occurs, the UE applies a duplication of uplink (UL) data in the packet data convergence protocol layer (PDCP), and duplicates transmission of the UL data through a plurality of radio link control layers (RLC).

### CITATION LIST

### Non-Patent Literature

Non-Patent Literature 1Industrial “Enhanced Internet of Things (IoT) and ultra-reliable and low latency communication (URLLC) support for NR,” RP-210854, 3GPP TSG RAN Meeting #91e, 3GPP, March 2021

### SUMMARY OF THE INVENTION

However, when a UE is simultaneously connected to a plurality of gNBs (which may be read as a cell), such as Dual Connectivity (DC), it is difficult for the UE to easily determine the ST state.

In addition, if the UE is determined to be in the ST state, the UE may apply a duplicate of the UL data but the network may not recognize that the UE applied the duplicate of the UL data.

Thus, the following disclosure has been made in light of this situation, and is intended to provide a terminal, a radio base station, and a radio communication method for adequately improving redundancy of transmission data in association with a deterioration of a communication quality in the radio section.

One aspect of the present disclosure is a terminal (UE 200) including: a transmission unit (data unit processor 220) that transmits uplink data to a first radio base station and a second radio base station; a reception unit (data unit processor 220) that receives a first negative response of an automatic retransmission request of the uplink data from the first radio base station and receives a second negative response of the automatic retransmission request from the second radio base station; and a control unit (control unit 240) that applies a duplication of the uplink data based on a sum of the number of the first negative responses and the number of the second negative responses, or either the number of the first negative responses or the second negative responses.

One aspect of the present disclosure is a terminal (UE 200) including a control unit (control unit 240) that applies a duplication of uplink data in response to a deterioration of a communication quality in a radio section, and a transmission unit (data unit processor 220) that transmits a control element of a medium access control layer to a network, the control element indicating that the deterioration has been determined or that the duplication of the uplink data has been applied.

One aspect of the present disclosure is a radio base station (gNB 100) including a transmission unit (retransmission processing unit 130) that transmits a retransmission permission of uplink data to a terminal, and a control unit (control unit 140) that assumes that when the retransmission permission is transmitted a specific number of times, the terminal has transitioned to a specific state in which a duplication of the uplink data is applied in response to a deterioration of a communication quality in a radio section.

One aspect of the present disclosure is a radio communication method including: a step of transmitting uplink data to a first radio base station and a second radio base station; a step of receiving a first negative response of an automatic retransmission request of the uplink data from the first radio base station; a step of receiving a second negative response of the automatic retransmission request from the second radio base station; and a step of applying a duplication of the uplink data based on a sum of the number of the first negative responses and the number of the second negative responses or either the number of the first negative responses or the number of the second negative responses.

One aspect of the present disclosure is a radio communication method including a step of applying a duplication of uplink data in response to a deterioration of a communication quality in a radio section, and a step of transmitting a control element of a medium access control layer to a network, the control element indicating that the deterioration has been determined or a duplication of the uplink data has been applied.

One aspect of the present disclosure is a radio communication method including a step of transmitting a retransmission permission of uplink data to a terminal, and a step of assuming that when the retransmission permission is transmitted a specific number of times, the terminal has transitioned to a specific state in which a duplication of the uplink data is applied in response to a deterioration of a communication quality in a radio section.

### BRIEF DESCRIPTION OF THE DRAWINGS

FIG. 1 is an overall schematic diagram of a radio communication system 10.

FIG. 2 is a functional block diagram of a gNB 100.

FIG. 3 is a functional block diagram of a UE 200.

FIG. 4 is a diagram showing an example of PDCP duplication in a ST state.

FIG. 5 is a diagram showing a transmission example (1) of UL data before application of PDCP duplication.

FIG. 6 is a diagram showing a transmission example (2) of UL data before application of PDCP duplication.

FIG. 7 is a diagram showing a transmission example (1) of UL data after application of PDCP duplication.

FIG. 8 is a diagram showing a transmission example (2) of UL data after application of a PDCP duplication.

FIG. 9 is a diagram showing a transmission example (3) of UL data after application of a PDCP duplication.

FIG. 10 is a diagram showing a transmission example of UL data according to an operation example 1.

FIG. 11 is a diagram showing a configuration example of the MAC CE according to an operation example 2.

FIG. 12 is a diagram showing an example of a hardware configuration of a gNB 100 and a UE 200.

FIG. 13 shows a configuration example of a vehicle 2001.

### BRIEF DESCRIPTION OF THE DRAWINGS

Hereinafter, the embodiment will be described based on the drawings. The same functions and structures are denoted by the same or similar reference numerals, and the description thereof will be omitted accordingly.

### (1) Overall Schematic Configuration of Radio Communication System

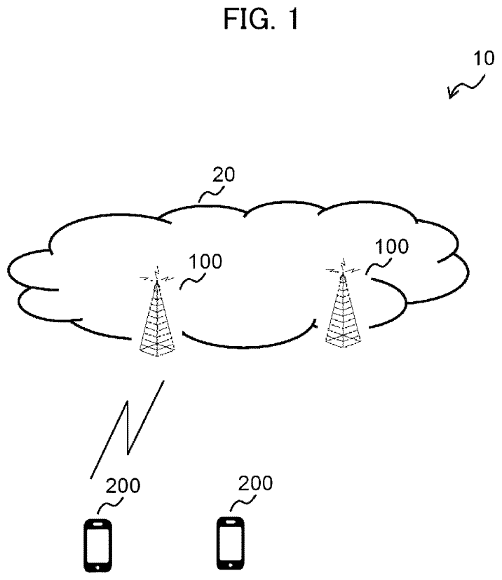

FIG. 1 is an overall schematic configuration of a radio communication system 10 according to a present embodiment. The radio communication system 10 is a radio communication system according to 5G New Radio (NR) and includes a Next Generation-Radio Access Network 20 (hereinafter referred to as NG-RAN 20 and a terminal 200 (user Equipment 200, hereafter referred to as UE 200).

Further, the radio communication system 10 may be a radio communication system according to a method called “Beyond 5G”, “5G Evolution” or “6G”, or may include a radio communication system according to a method called Long Term Evolution (LTE) or 4G. The radio communication system 10 may support functions related to the Industrial Internet of Things (IIoT) and URLLC (Ultra-Reliable and Low Latency Communications).

The NG-RAN 20 includes a radio base station 100 (hereafter referred to as gNB 100). A specific configuration of the radio communication system 10 including the number of gNBs (or eNBs and the like) and UEs is not limited to the example shown in FIG. 1.

The NG-RAN 20 actually includes a plurality of NG-RAN nodes, specifically gNBs (or ng-eNBs) and is connected to a core network (5GC, not shown) according to 5G. The NG-RAN 20 is connected to an Access and Mobility Management Function (AMF), a Session Management Function (SMF), and the like, which are included in a 5G system architecture and provide access and mobility management functions for the UE 200. It should be noted that the NG-RAN 20 and 5GC may simply be referred to as a “network”.

The gNB 100 is a radio base station in accordance with the NR, and performs a radio communication with the UE 200 according to the NR. Further, the gNB 100 may be composed of a CU (Central Unit) and a DU (Distributed Unit), and the DU may be separated from the CU and installed in a geographically different location. Further, the gNBs 100 (gNB-CUs) may be connected by an Xn interface.

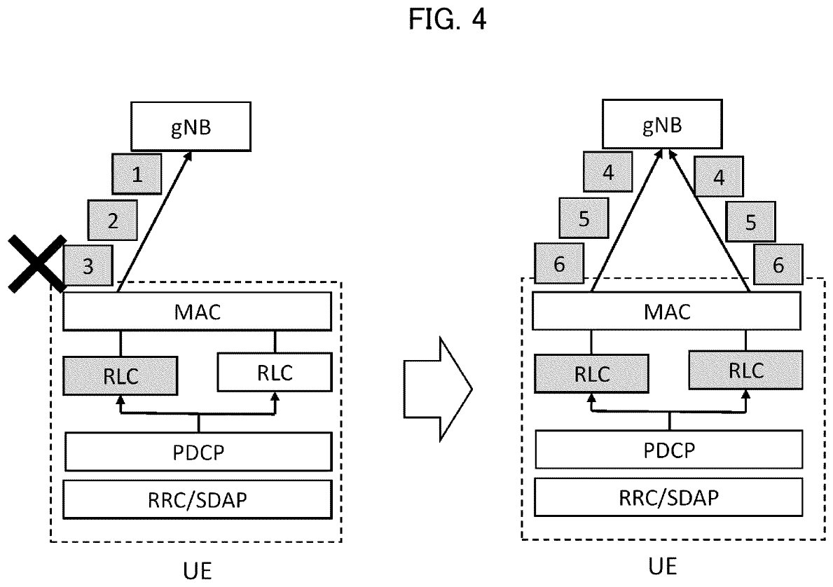

The gNB 100 and the UE 200 can support a Massive MIMO, which generates a more directional beam (not shown in FIG. 1, see FIG. 4) by controlling radio signals transmitted from a plurality of antenna elements; a Carrier Aggregation (CA), which uses a plurality of Component Carriers (CCs) bundled together; and Dual Connectivity (DC), which simultaneously communicates between the UE and a plurality of NG-RAN nodes.

The type of DC can be Multi-RAT Dual Connectivity (MR-DC), which utilizes a plurality of radio access technologies; or NR-NR Dual Connectivity (NR-DC), which utilizes only NR. Further, the MR-DC can be E-UTRA-NR Dual Connectivity (EN-DC), in which the eNB constitutes a master node (MN) and the gNB constitutes a secondary node (SN), or vice versa, NR-E-UTRA Dual Connectivity (NE-DC). Furthermore, in the radio communication system 10, triple connectivity may be applied whereby the UE 200 connects to three gNBs 100 simultaneously.

In DC, a master cell group (MCG) and a secondary cell group (SCG) may be set. The MCG may include a primary cell (PCell), and the SCG may include a secondary cell (SCell).

The SCell may include a primary-secondary cell (PSCell). A PSCell is a type of SCell, but may be interpreted as a special SCell having a function equivalent to a PCell. In the PSCell, similarly to the PCell, a transmission of a Physical Uplink Control Channel (PUCCH), a procedure of Contention-Based Random Access (CBRA), and a radio link monitoring function and the like may be conducted.

The gNB 100 and the UE 200 perform the radio communication via a radio bearer, specifically a Signalling Radio Bearer (SRB) or DRB Data Radio Bearer (DRB). If DC is set, a radio bearer via a MCG and a SCG may be set, and a split bearer may be set that branches from one of the MCG (MN) or the SCG (SN) to the other one of the MCG (MN) or the SCG (SN) and set between the MCG and the SCG and the UE 200.

In addition, in the radio communication system 10, when a state in which a communication quality of the radio section (between the UE and the gNB) becomes degraded (the state may be called “Survival Time State (ST state)”), an operation to increase the redundancy of transmitted data may be executed.

The determination of the ST state may be based, for example, on the number of times (which may be once) that a negative acknowledgment (HARQ-NACK) of a hybrid automatic repeat request (HARQ) is received. However, in addition to HARQ-NACK, if the communication quality of the radio section can be determined, it may be based on other indicators. The ST state may be called a “specific state” in this embodiment.

The operation of increasing the redundancy of transmitted data may typically mean that transmitted data (Protocol Data Unit: PDU or Service Data Unit: SDU, and the like.) is duplicated and the duplicated transmitted data of the same content is transmitted simultaneously or with a time difference to the same or a different destination “which may be called overlapping transmission of transmitted data”.

Such duplicate and overlapping transmission of transmission data may be applied to an uplink (UL) and/or a downlink (DL). In this embodiment, an example in which duplicate and overlapping transmission of the transmitted data is applied to the UL will be described.

### (2) Function Block Configuration of Radio Communication System

Next, a function block configuration of the radio communication system 10 will be described. Specifically, the function block configuration of the gNB 100 and the UE 200 will be described.

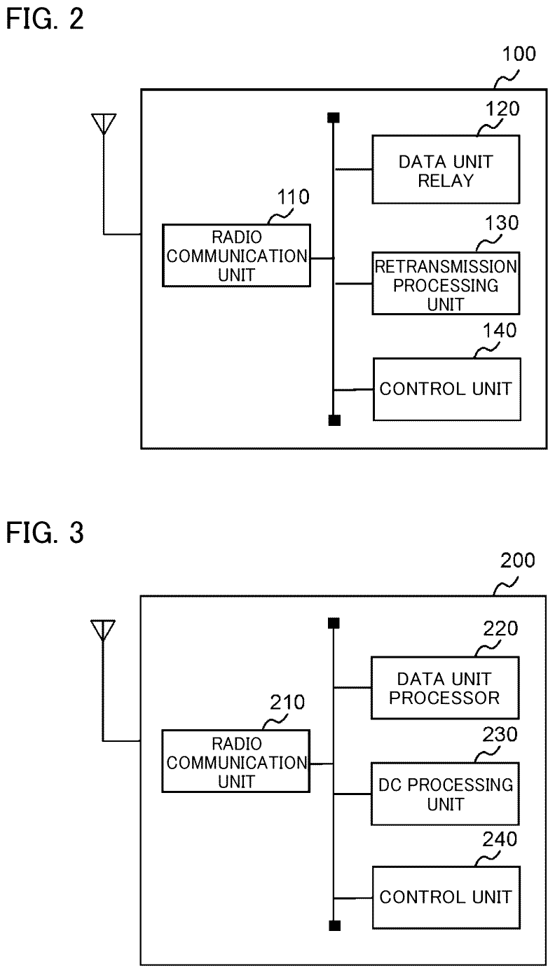

FIG. 2 is a function block configuration diagram of the gNB 100. FIG. 3 is a function block configuration diagram of the UE 200. It should be noted that only the main function blocks related to the description of the embodiment are shown in FIGS. 2 and 3, and the gNB 100 and the UE 200 have other function blocks (for example, the power supply unit and the like). FIGS. 2 and 3 show a functional block configuration of the gNB 100 and the UE 200, respectively. Refer to FIG. 12 for a hardware configuration.

(2.1) gNB 100

As shown in FIG. 2, the gNB 100 includes a radio communication unit 110, a data unit relay 120, a retransmission processing unit 130, and a control unit 140.

The radio communication unit 110 transmits a downlink signal (DL signal) in accordance with the NR. The radio communication unit 110 receives an uplink signal (UL signal) in accordance with the NR.

A data unit relay 120 relays data transmitted and received between the UE 200 and the 5 GC (core network) using a predetermined channel. Specifically, the data unit relay 120 can perform relay processing (which may be read as routing or forwarding) according to a destination address of the data (which may be read as a packet or data unit (PDU, SDU)) transmitted or received by the UE 200.

Further, the data may mean user data transmitted and received via a user plane, but may include control data transmitted and received via a control plane.

Channels include control channels and data channels. The control channels include Physical Downlink Control Channel (PDCCH), Physical Uplink Control Channel (PUCCH), Physical Random Access Channel (PRACH), Physical Broadcast Channel (PBCH), and the like. The data channels include Physical Downlink Shared Channel (PDSCH), Physical Uplink Shared Channel (PUSCH), and the like.

A retransmission processing unit 130 executes retransmission processing of data transmitted and received by the data unit relay 120. Specifically, the retransmission processing unit 130 executes retransmission processing in accordance with HARQ.

In particular, the retransmission processing unit 130 can transmit an affirmative response (HARQ-ACK) or a negative response (HARQ-NACK) to the data (uplink data (UL data)) transmitted from the UE 200 to the UE 200 based on the HARQ.

Further, the retransmission processing unit 130 can transmit a retransmission permission of the UL data to the UE 200. In this embodiment, the retransmission processing unit 130 may constitute a transmission unit that transmits the retransmission permission of the UL data.

Specifically, the retransmission processing unit 130 may transmit a retransmission permission (UL grant) of the UL data based on the HARQ to the UE 200. The UL data subject to the retransmission permission may be based on the UL data that could not be received normally and returned the HARQ-NACK.

The control unit 140 controls each function block constituting the gNB 100. In particular, in the present embodiment, the control unit 140 executes a control for retransmission of the UL data.

Specifically, the control unit 140 may assume (deem) that the UE 200 has transitioned to a survival time state (ST state) when the retransmission processing unit 130 transmits a permission of retransmission (UL grant) of the UL data a specific number of times. The specific number of times may be once or the number of times equal to or more than twice. Alternatively, a transition to the ST state may be assumed when the permission of retransmission are transmitted consecutively, or when permissions of retransmission are transmitted a specific number of times within a predetermined time.

As described above, the ST state is a state in which a UL data duplication is applied in response to a deterioration of a communication quality in a radio section (or may be interpreted as a state of overlapping transmission of the UL data with the deteriorated communication quality of the radio section).

When the control unit 140 deems that the UE 200 has entered the ST state, the control unit 140 may notify the other gNBs via an Xn interface of a message containing information indicating that the UE 200 is deemed to have entered the ST state. For example, when the own node is SN, the control unit 140 may transmit a message containing the information to the gNB constituting the MN, or the MN may transmit the message to the SN.

Further, if the gNB is separated into the CU and the DU as described above (CU-DU split gNB), the DU generates the permission of retransmission (UL grant), so that the DU can recognize that the UE 200 has entered the ST state before the CU. In this case, the DU may notify the CU via the F1 interface and the CU may notify the other gNB (CU) via the Xn interface that the UE has entered the ST state. Further, the other gNB (CU) may notify the DU under the CU via the F1 interface that the UE has entered the ST state.

### (2.2) UE 200

As shown in FIG. 3, the UE 200 includes a radio communication unit 210, a data unit processor 220, a DC processing unit 230, and a control unit 240.

The radio communication unit 210 transmits an uplink signal (UL signal) in accordance with the NR. The radio communication unit 210 receives an uplink signal (DL signal) in accordance with the NR.

The data unit processor 220 transmits and receives data to and from the 5 GC (core network) or an external network (which may include the Internet) connected to the 5 GC via the gNB 100. Specifically, the data unit processor 220 transmits data (which may be packets or data units (PDU, SDU)) to the gNB 100 using a predetermined channel and receives data from the gNB 100.

The data unit processor 220 can execute processing related to a duplication and overlapping transmission of the UL data. Specifically, when the UE 200 is in the ST state (specified state), the data unit processor 220 may duplicate (read as a copy) the UL data (which may be packet or data unit) and transmit the duplicated UL data to one or a plurality of different gNBs.

For example, the data unit processor 220 may transmit the duplicated UL data to a specific gNB (which may be the first radio base station, MN) and to a specific gNB and another gNB (second radio base station, may be SN). In this embodiment, the data unit processor 220 may constitute a transmission unit that transmits UL data to the first radio base station and the second radio base station.

Duplicate and overlapping transmission of the UL data may be realized by applying a duplication of the UL data (PDU) in a packet data convergence protocol layer (PDCP) and overlappingly transmitting the UL data duplicated through a plurality of radio link control layers (RLC).

A data unit processor 220 also executes processing related to a HARQ. Specifically, the data unit processor 220 may receive a HARQ-NACK (first negative response) of a UL data from a specific gNB (which may be a first radio base station, MN). The data unit processor 220 may receive a HARQ-NACK (second negative response) of the UL data from the specific gNB and another gNB (which may be a second radio base station, SN). In this embodiment, the data unit processor 220 may constitute a reception unit that receives the first negative response and the second negative response.

More specifically, the data unit processor 220 may receive a HARQ-NACK (or HARQ-ACK) from each of at least two connected gNBs (which may be cells) during the execution of dual connectivity.

Further, the data unit processor 220 may transmit a control element (MAC CE) of the medium access control layer (MAC), indicating a determination that the communication quality of the radio section has been deteriorated, that is, the ST state has occurred, to the network.

Alternatively, the data unit processor 220 may transmit a MAC CE indicating that a UL data duplication has been applied to the network. In this embodiment, the data unit processor 220 may constitute a transmission unit that transmits a control element of the media access control layer (MAC) to the network, the control element indicating that the communication quality of the radio section has deteriorated or that the UL data duplication has been applied.

The DC processing unit 230 executes processing related to dual connectivity, specifically, MR-DC. Specifically, the DC processing unit 230 may execute processing related to NR-DC, but may executes processing related to NE-DC and/or EN-DC.

The DC processing unit 230 may access a plurality of gNBs 100 and execute settings in a plurality of layers (a media access control layers (MAC), a radio link control layer (RLC), a packet data convergence protocol layer (PDCP), and the like) including RRC.

The control unit 240 controls each function block constituting the UE 200. In particular, in the present embodiment, the control unit 240 can execute a control for determination of a ST State and reproduction of UL data.

Specifically, the control unit 240 may be suitable for reproducing UL data in accordance with a deterioration of the communication quality of the radio section. The deterioration of the communication quality of the radio section may be based on the number of times the HARQ-NACK is received, as described above, but is not necessarily limited to the HARQ-NACK. The control unit 240 may determine the deterioration of the communication quality of the radio section (that is, transition to the ST state) based on not only the number of times the HARQ-NACK is received but also the communication quality of the RLC or cell level falling below a predetermined value regardless of the number of times the HARQ-NACK is received.

More specifically, the control unit 240 may determine whether a UL data duplication is to be applied based on the number of HARQ-NACKs (first negative response) from specific gNB (which may be a first radio base station, MN) received by the data unit processor 220 and the number of HARQ-NACK (second negative response) from the specific gNB and another gNB (which may be a second radio base station, SN).

For example, the control unit 240 may apply a UL data duplication based on a sum of the number of HARQ-NACKS from the MN and the number of HARQ-NACKS from the SN. Specifically, when the sum exceeds a predetermined value, it may be determined to be in the ST state and apply the UL data duplication.

Alternatively, the controller 240 may apply a duplicate of the UL data based on either the number of HARQ-NACKs from the MN or the number of HARQ-NACKs from the SN. Specifically, if one of these numbers exceeds a predetermined value, it may be determined to be in the ST state and decided an application of the UL data duplication.

### (3) Operation of Radio Communication System

Next, the operation of a radio communication system 10 will be described. Specifically, the operation related to the Survival Time State (ST State) of the UE 200 will be described.

### (3.1) Assumption and Problem

With respect to IIoT support, 3GPP Release-17 examines the ability to automatically increase data transmission redundancy when the UE is in the ST state (in other words, if the communication quality is poor). Specifically, when the UE enters the ST state, it can apply duplicate of data (PDU/SDU) at a PDCP layer (PDCP duplication) and transmit duplicated data through multiple RLC layers.

FIG. 4 shows an example of PDCP duplication in the ST state. As shown on the left of FIG. 4, the UE may enable PDCP duplication when the number of HARQ-NACKs for packets of the UL data (or data unit, frame 1 to 3 in the drawings) exceeds a predetermined value.

Specifically, the UE may enable PDCP duplication through the pre-configured RLC entity when the number of times of the HARQ-NACK transmitted from the gNB>the predetermined number N holds in the MAC entity.

As a result, as shown in FIG. 4, the UE transmits a packet of UL data (frame 4 to 6 in the drawing) duplicated through the two RLC entities to the gNB. The number in the frame indicates the number (order) of the packet (the same applies hereinafter).

In this embodiment, a PDCP duplication of UL data will be described, but the PDCP duplication of DL data may be applied.

### (3.2) Example of UL Data Transmission

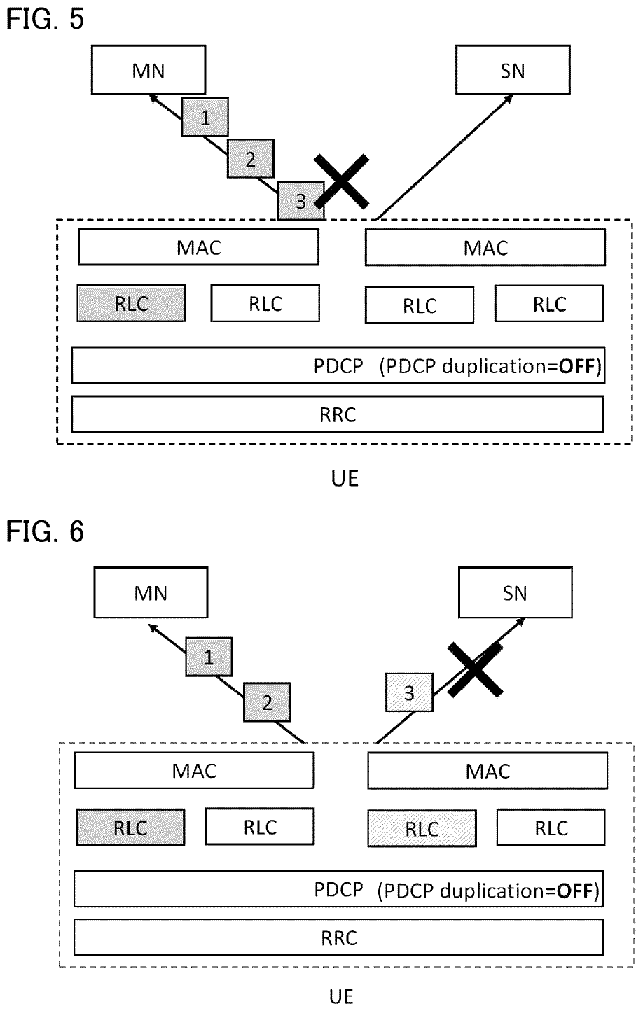

Next, an example of UL data transmission before and after application of PDCP duplication will be described. FIG. 5 shows an example of UL data transmission (1) before application of PDCP duplication. In the example shown in FIG. 5, only MCG bearers are set. In this case, when the number of times of the HARQ-NACK>the predetermined number N holds in the MCG, PDCP duplication through the pre-configured RLC entity may be enabled.

The timing at which the UE MAC entity identifies the HARQ-NACKs may be in accordance with any of the following:
Re-transmission DCI (Downlink Control Information) is scrambled by CS-RNTI (Configured Scheduling-Radio Network Temporary Identifier) with NDI=1.
HARQ Process ID corresponds to CG (Configured Grant) (for the same HARQ process ID).
NDI (New Data Indicator) received on the PDCCH is not toggled compared to the value of the previous received transmission corresponding to this TB.
The Configured grant timer of CG is running or HARQ process is pending.

FIG. 6 shows an example of transmission (2) of the UL data before application of PDCP duplication. In the example shown in FIG. 6, a split bearer is set. In the case of the split bearer, when the number of times of the HARQ-NACK>the predetermined number N holds in the MCG or SCG, PDCP duplication through the pre-configured RLC entity may be enabled.

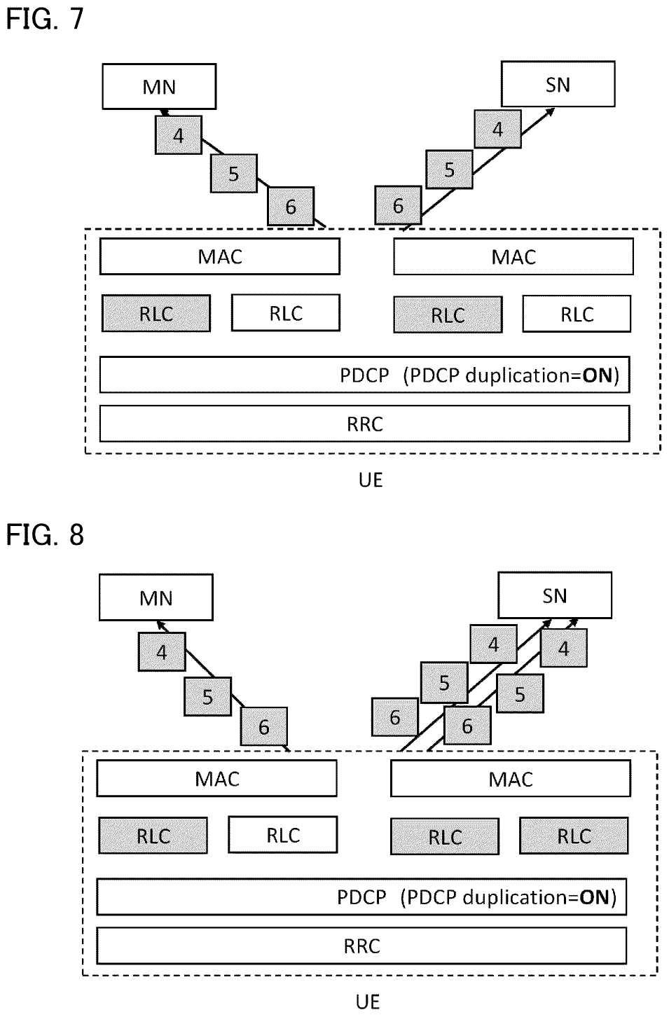

FIG. 7 shows an example of transmission (1) of the UL data after application of PDCP duplication. In the example shown in FIG. 7, in the split bearer, PDCP duplication is enabled (may be read as activate) through some of the pre-configured RLC entities.

As shown in FIG. 7, after PDCP duplication is applied, that is, when PDCP duplication is enabled and the number of times of the HARQ-NACK>the predetermined number N holds in the MAC entities of the MCG (MN) and the SCG (SN), PDCP duplication through the pre-configured RLC entity may be enabled. As a result, as shown in FIG. 7, packets of #4 to 6 are duplicated and transmitted to each of the MN and the SN.

Further, which RLC entity activates PDCP duplication in the ST state may be set in advance by signaling in an upper layer (for example, RRC), or the UE may judge based on the communication quality of the DL. After the activation of PDCP duplication, the UE may inform the network (gNB) of the status of PDCP duplication through the RLC entity.

FIG. 8 shows an example of transmission (2) of the UL data after application of PDCP duplication. As shown in FIG. 8, when the communication quality on the SN side is particularly poor (when the number times of HARQ-NACK is large), PDCP duplication through the RLC entity on the SN side may be increased.

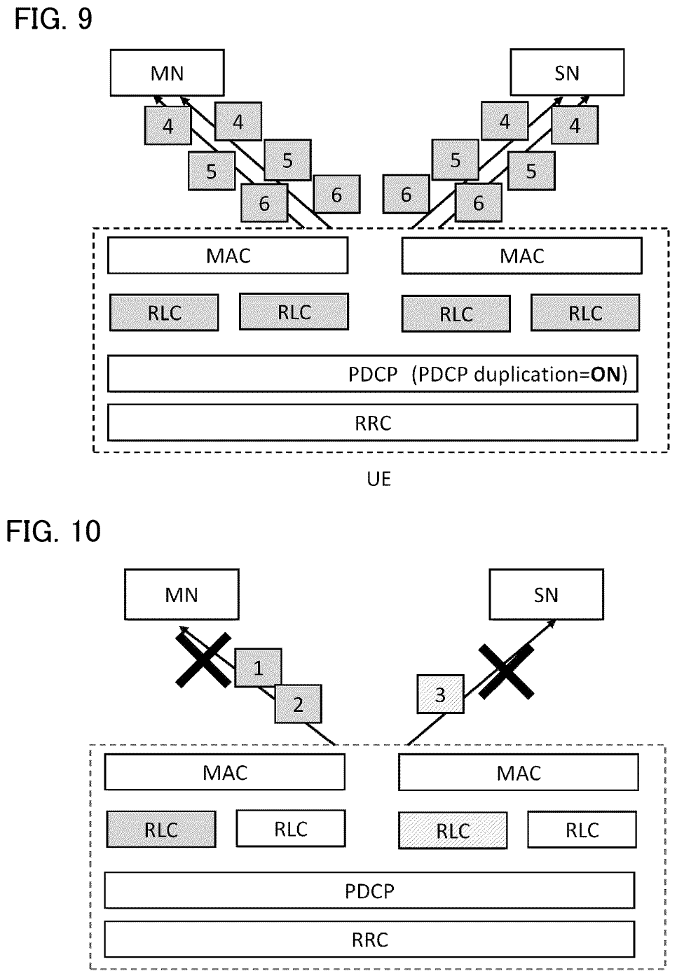

FIG. 9 shows an example of transmission (3) of the UL data after application of PDCP duplication. In the example of FIG. 9, PDCP duplication is enabled through all pre-configured RLC entities in the split bearer. Further, up to four RLC entities can be set in 3GPP (one is always enabled).

### (3.3) Example of Operation

Next, an example of operation related to a criteria for the UE to transition to the ST state and an example of operation in which the UE reports to the network that it has applied duplication and overlapping transmission of the UL data will be described.

### (3.3.1) Example of Operation 1

As described above, for example, in the case of split bearer, the UL data is transmitted to both a MN and a SN in dual connectivity (DC). Thus, the UE may be notified of HARQ-NACKs from both the MN and the SN.

FIG. 10 shows an example of transmission of UL data according to the operation example 1. As shown in FIG. 10, the UE can transmit packets of #1 and #2 to the MN and a packet #3 to the SN via the split bearer. If these packets cannot be successfully received by the MN and SN, the HARQ-NACK is notified from both the MN and SN.

In this case, it comes into question what criteria the UE applies to transition to the ST state based on the number of HARQ-NACKs received from both the MN and SN.

In this operation example, the UE may be determine to transition to the ST state if any of the following criteria it satisfied:
(Option 1): A sum of the number of HARQ-NACKS received in the MAC entity opposed to the MN and the number of HARQ-NACKs received in the MAC entity opposed to the SN exceeds the predetermined number of times N.

In this case, PDCP duplication through some or all pre-configured RLC entities may be enabled.

The UE may also determine a transition to the ST State, that is activation of PDCP duplication, based on the RLC or cell-level communication quality falling below a predetermined value in addition to (or separately from) the total number of HARQ-NACKS.

The method of activation of some or all pre-configured RLC entities (for example, which RLC entity has a priority), and/or the value of N a predetermined number of times, may be set in advance by signaling in the upper layer (for example, RRC).
(Option 2): One or more predetermined number of HARQ-NACKs have been received in either the MAC entity at the MCG or the MAC entity at the SCG.

In this case, as in the option 1, operations related to the transition to the ST state and activation of PDCP duplication may be executed.

### (3.3.2) Example of Operation 2

As described above, when the UE (MAC entity) receives a predetermined number of HARQ-NACKs, it can transition to the ST state and automatically enable (activate) PDCP duplication.

However, the network cannot recognize in which RLC entity (which may be read as RLC leg) the UE has enabled PDCP duplication. Thus, a state mismatch of PDCP duplication in RLC and/or PDCP may occur between the UE and the network. Specifically, the following cases are possible.
(Case 1): In the case of DC, a MN cannot recognize the transition to the ST state even if the UE transitions to the ST state due to the occurrence of HARQ-NACK on the SN side since the MN does not recognize the communication quality and communication status on the SN side.

Specifically, even if the UE transitions to the ST state due to the occurrence of HARQ-NACK on the SN side, as in the UL data transmission example shown in FIG. 6, the MN may not recognize the transition to the ST state.
(Case 2): In the case of DC, when the number of HARQ-NACKs in the each MAC entity of the MN and the SN exceeds a predetermined value, for example, PDCP duplication is activated on the MN side, but the MN cannot recognize the occurrence status of HARQ-NACKs on the SN side and cannot recognize the total number of HARQ-NACKs in the MAC entities of the MN and the SN.
(Case 3): As in the example of transmission of the UL data shown in FIGS. 7 and 8, the UE can select the RLC entity used for PDCP duplication, and thus the network cannot recognize the details of activation of PDCP duplication.
(Case 4): The UE may transition to ST state when it is not able to receive HARQ feedback (HARQ-ACK or HARQ-NACK) from the network. Again, the network cannot recognize the activation of PDCP duplication.

Such a case may occur not only in the case of DC but also in the case of non-DC (standalone).

To eliminate such a problem, the UE or gNB may operate by one of the followings:
(Option 1): If a UE (MAC entity) transitions to the ST state, it sends a MAC CE indicating that it has transitioned to the ST state to the network.

In the case of DC, the UE may send the MAC CE to the MN and the SN, respectively. Together, an identification (ID) of an associated data radio bearer (DRB) and/or the ID of the RLC may be transmitted. Further, information indicating whether PDCP duplication through the RLC entity has been activated may be transmitted.

Alternatively, such a content may be transmitted to the network using a PUCCH or RRC message (which may be a bitmap).

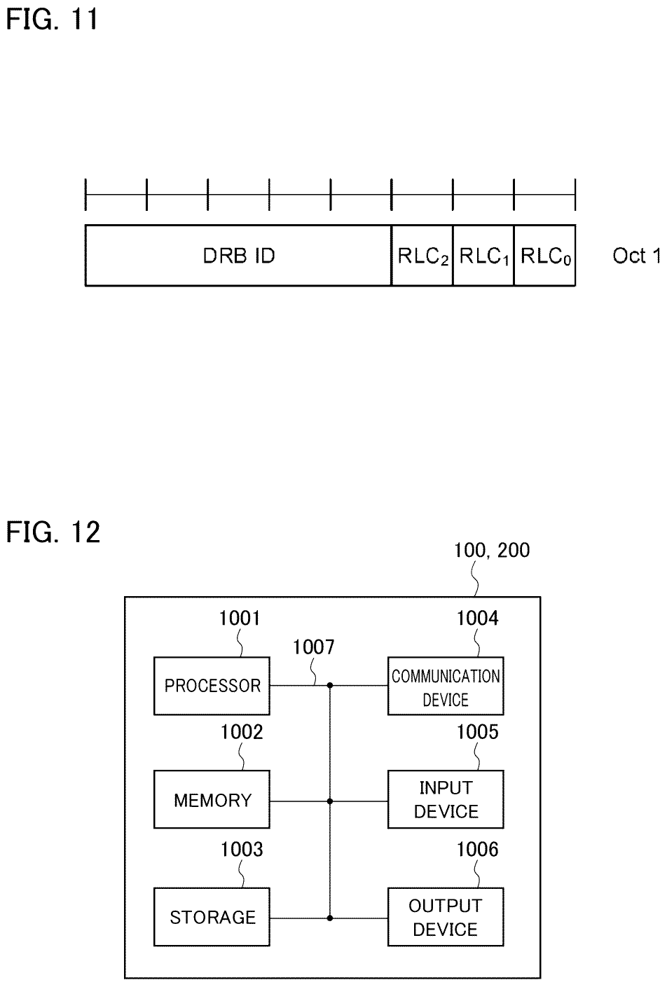

FIG. 11 shows a configuration example of the MAC CE according to the operation example 2. As shown in FIG. 11, the MAC CE indicating the transition to the ST state may be comprised of 1 octet.

The MAC CE may have the same structure as the Duplication RLC Activation/Deactivation MAC CE specified in Section 6.1.3.32 of 3GPP TS38.321. As described above, up to four RLC entities can be set, but since one is always activated, 3 bits (RLC 0 to 2) may be assigned to an ID display of the RLC entity.
(Option 2): The gNB (for example, SN) may assume (deem) that the UE has transitioned to the ST state if it has sent a retransmission grant to the UE a predetermined number of times N.

In this case, the gNB (SN), may notify the other gNB (for example, MN) via an Xn interface of a message containing information indicating that the UE has deemed that it has entered the ST state.

Further, in the case of the gNB separated into the CU and the DU as described above (CU-DU split gNB), the SN (DU) generates a permission of retransmission (UL grant), so that the DU can recognize that the UE 200 has entered the ST state before the CU. In this case, the DU may notify the CU via the F1 interface and the CU may notify the MN (CU) via the Xn interface that the UE has entered the ST state. Furthermore, the MN (CU) may notify the DU under the MN via the F1 interface that the UE has entered the ST state.

### (4) Operation and Effect

According to the above-described embodiment, the following operation and effect can be obtained. Specifically, according to the gNB 100 and the UE 200, a state mismatch between the UE 200 and a network in PDCP duplication due to the transition to the ST state can be reliably avoided.

Thus, the gNB 100 and the UE 200 can appropriately cope with the redundancy improvement of the transmitted data due to the deterioration of the communication quality in the radio section.

### (5) Other Embodiments

Although the embodiments have been described above, they are not limited to the description of the embodiments, and it is obvious to those skilled in the art that various modifications and improvements can be made.

For example, in the above-described embodiments, the term “ST state” is used, but “ST state” is a tentative name and may be called by another name. As described above, an ST state may be interpreted as a state in which the communication quality of a radio section (between UE and gNB) is deteriorated (poor), a state in which it is uncertain whether communication can be maintained, and the like.

In the above description, configure, activate, update, indicate, enable, specify, and select may be interchangeably interpreted. Similarly, link, associate, correspond, and map may be interchangeably interpreted, and allocate, assign, monitor, and map may also be interchangeably interpreted.

In addition, specific, dedicated, UE-specific, and UE-dedicated may be interchangeably interpreted. Similarly, common, shared, group-common, UE-common, and UE-shared may be interchangeably interpreted.

The block diagram (FIGS. 2 and 3) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

Further, the above-described gNB 100 and UE 200 (the device) may function as a computer that performs processing of a radio communication method of the present disclosure. FIG. 12 is a diagram illustrating an example of a hardware configuration of the device. As illustrated in FIG. 12, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIGS. 2 and 3) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a base station. In this case, the base station may have the function of the mobile station. A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIS (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a subcarrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

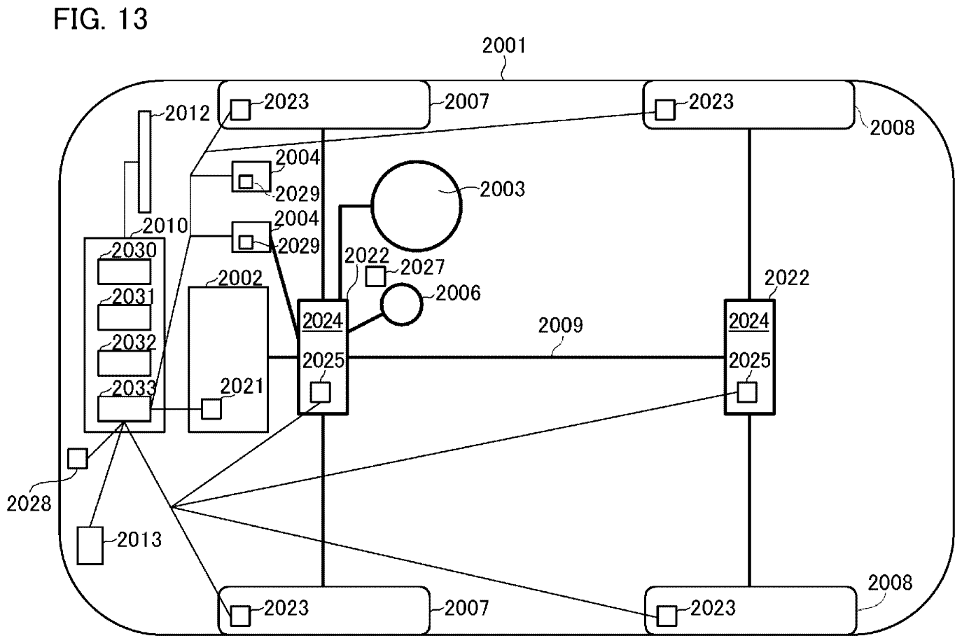

FIG. 13 shows a configuration example of a vehicle 2001. As shown in FIG. 13, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor. The steering 2003 includes at least a steering wheel (also called a handle) and steers at least one of the front and rear wheels based on an operation of a steering wheel operated by a user. The electronic controller 2010 includes a microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a light detection and ranging (LiDAR), a camera, a positioning locator (for example, GNSS), map information (for example, high-definition (HD) maps, autonomous vehicle (AV) maps, and the like), a gyroscopic system (for example, an inertial measurement unit (IMU), an inertial navigation system (INS), and the like), an artificial intelligence (AI) chip, and an AI processor for providing functions to prevent accidents or reduce a driving load of a driver, and one or more ECUs for controlling these devices. Further, the driver support system unit 2030 transmits and receives various kinds of information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a base station, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like. provided in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
110 Radio communication unit
120 Data unit relay
130 Retransmission processing unit
140 Control unit
200 UE
210 Radio communication unit
220 Data unit processor
230 DC processing unit
240 Control unit
1001 Processor
1002 Memory
1003 Storage
1004 Communication device
1005 Input Device
1006 Output device
1007 Bus
2001 Vehicle
2002 Drive
2003 Steering
2004 Axel pedal
2005 Brake pedal
2006 Shift lever
2007 Left and right front wheels
2008 Right and left rear wheels
2009 Axle
2010 Electronic controller
2012 Information service unit
2013 Communication module
2021 Current sensor
2022 Speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system
2031 Microprocessor
2032 Memory (ROM, RAM)
2033 Communication port

1.-6. (canceled)

7. A terminal comprising:
a reception unit that receives a retransmission permission from a base station, and
a control unit that transitions the terminal to a state in which a duplication of uplink data is applied when the retransmission permission is received a predetermined number of times.

8. A base station comprising:
a transmission unit that transmits a retransmission permission to a terminal, and
a control unit that assumes that when the retransmission permission is transmitted a predetermined number of times, the terminal has transitioned to a state in which a duplication of uplink data is applied.

9. A communication method for a terminal comprising:
a step of receiving a retransmission permission from a base station, and
a step of transitioning the terminal to a state in which a duplication of uplink data is applied when the retransmission permission is received a predetermined number of times.

10. A communication system comprising:
a base station including:
a transmission unit that transmits a retransmission permission to a terminal, and
a control unit that assumes that when the retransmission permission is transmitted a predetermined number of times, the terminal has transitioned to a state in which a duplication of uplink data is applied, and
the terminal including:
a reception unit that receives the retransmission permission from the base station, and
a control unit that transitions the terminal to a state in which the duplication of the uplink data is applied when the retransmission permission is received a predetermined number of times.
